(19) United States
(12) Patent Application Publication
(10) Pub. No.: US 2007/0150861 A1
(43) Pub. Date: Jun. 28, 2007

(54) Method and system for software design that combines signal flow and object reference connections

(75) Inventor: Steven C. Bray, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/187,909

(22) Filed: Jul. 25, 2005

Related U.S. Application Data
(63) Continuation-in-part of application No. 11/184,824, filed on Jul. 20, 2005, now abandoned.

(51) Int. Cl. G06F 9/44

(52) U.S. Cl. 717/109

(57) ABSTRACT

A method and system for designing and generating instructions for a computing device are disclosed. The system includes one or more consoles and a product library configured to store software blocks. A console includes a user interface for receiving user input and displaying graphical representations of software blocks selected from the product library. The user interface is adapted to permit a selection of graphical connections between the graphical representations of software blocks. The selection of graphical connections includes a signal flow connection and an object reference connection.

This application is a continuation-in-part of application Ser. No. ______, entitled “METHOD AND SYSTEM FOR SOFTWARE COMPONENT DESIGN,” filed Jul. 20, 2005.

### TECHNICAL FIELD

The present disclosure relates to software development systems and methods and, more particularly, a system and method for automatically generating software instructions for a work machine controller.

### BACKGROUND

Software instructions can be designed using a computer-generated design environment. A design environment may include a system design tool that facilitates a function-based approach to designing software, and a database that stores software blocks available to the design tool for generating the software instructions. Each software block stored in the database may perform a particular function and have particular properties.

In operation, a system design tool may present a graphical user interface (GUI) to a user, and through the GUI, the design tool may accept user input indicating a plurality of sub-functions that the system would have to perform in order to perform the overall function of the system. The user input may also indicate types of interaction between the sub-functions. The design tool may then identify from the database the software blocks that can perform the inputted sub-functions, and may conceptually build a graphical representation of the software instructions by connecting the identified software blocks according to the inputted interaction of the sub-functions. The database identifying the software blocks is often referred to as a catalog or library.

In a design environment where a system design tool assembles different existing software blocks identified in a catalog to build a software system, each software block is preferably configured to work with other software blocks in the catalog. Conventional software design methods, however, require a designer to specifically design a software block to work in a particular software system. Thus, the number and variety of software blocks available to a system design tool are limited because software blocks are generally designed for a particular system, and thus may not work in a new system designed using the system design tool.

At least one system is known for developing software instructions using previously developed software blocks. For example, U.S. Pat. No. 6,405,364 (“the '364 patent”) to Bowman-Amuah dated Jun. 11, 2002, describes a system for building software in a development architecture framework using software components or blocks. Particularly, the system of the '364 patent includes various tools for graphically depicting software instructions with various modeling tools. For example, a data modeling tool disclosed in the '364 patent depicts logical constructs such as entities, attributes, and relationships between entities and physical constructs such as database definitions and table indices. Other modeling tools contemplated in the '364 patent include process modeling tools, event modeling tools, performance modeling tools, application logic design tools, and database design tools.

While the system of the '364 patent may be effective for modeling software instructions with various different types of modeling tools, the system of the '364 patent includes several disadvantages. For example, the system does not permit combining or mixing of modeling methodologies associated with different modeling tools into one modeling tool. Moreover, the '364 patent requires familiarity with several different modeling tools in order to be maximally useful to a designer. For example, a designer who is familiar with one modeling tool may decide it is easier to use that particular modeling tool to design every aspect of a software system, rather than expend efforts learning a new modeling approach that may be better suited to particular aspects of the software system.

The present disclosure is directed to overcoming one or more of the problems or disadvantages existing in the prior art.

### SUMMARY OF THE INVENTION

One disclosed embodiment includes a method for designing and generating instructions for a computing device. The method may include displaying, through a user interface, a menu of software blocks stored in a product library. The method may further include receiving user input for selecting software blocks from the menu and for connecting the selected blocks. Based on the received input, instructions may be automatically generated. The user interface may be adapted to permit a selection of graphical connections between the graphical representations. The selection of graphical connections may include an object reference connection and a signal flow connection.

A second disclosed embodiment includes a system for designing and generating instructions for a computing device. The system may include a library configured to store software blocks, and a console. The console may include a user interface for receiving user input and displaying graphical representations of software blocks selected from the library. The user interface may be adapted to permit a selection of graphical connections between the graphical representations of software blocks. The selection of graphical connections may include an object reference connection and a signal flow connection.

### BRIEF DESCRIPTION OF THE DRAWINGS

FIG. 1 provides a diagrammatic illustration of a system, according to an exemplary disclosed embodiment.

FIG. 2 provides a view of a user interface displayed on a console within the system of FIG. 1.

FIG. 3 provides a flow chart of an exemplary method that may be performed by the disclosed system.

### DETAILED DESCRIPTION

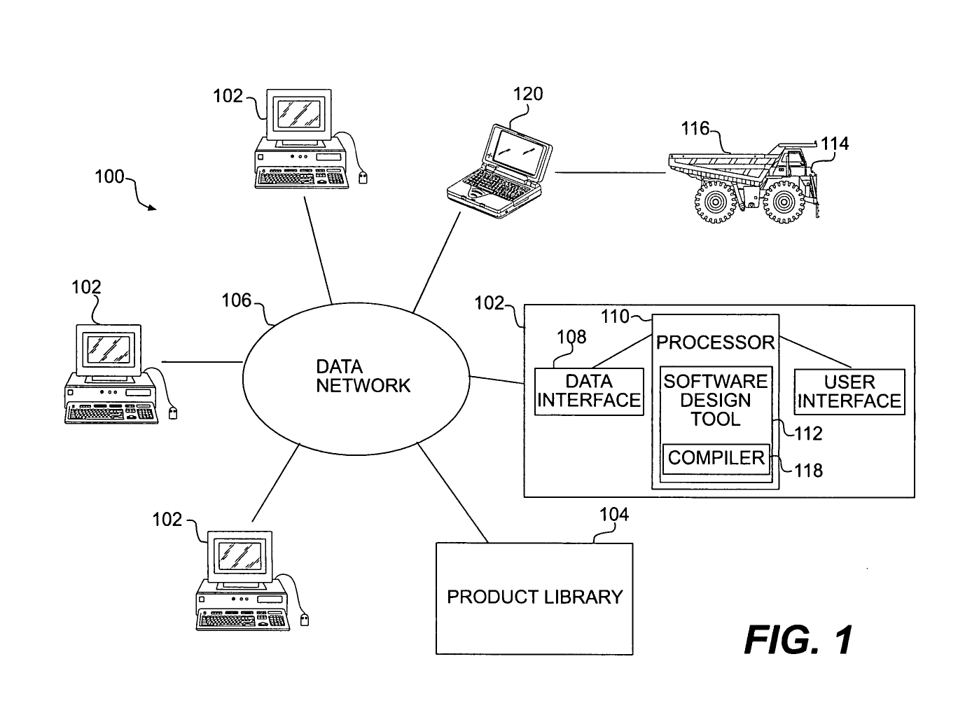

FIG. 1 is a diagrammatic illustration of a system 100 for designing and generating instructions for a computing device. System 100 may include various consoles 102 and a product library 104 for storing reusable software blocks. Each of consoles 102 and product library 104 may be operably connected to each other via a data network 106.

Console 102 may include a data interface 108 and a processor 110 for running a software design tool 112. Software design tool 112 may be used to design and automatically generate instructions for a computing device, such as a work machine controller 114 on board a work machine 116. Work machine controller 114 may be, for example, a processor for controlling an engine system, an on-board electrical or communications system, a hydraulic system, or various other systems associated with work machine 116.

Software design tool 112 may include a compiler 118. Compiler 118 may generate instructions based on a graphical representation of the instructions. The graphical representation may be composed of graphical representations of software blocks selected from a menu. After a user has designed a graphical representation of instructions, the instructions may be compiled for work machine controller 114 to execute. In an exemplary embodiment, the instructions may include a file, such as a distributed library, for storing the selected software blocks. The selected software blocks may be transferred from product library 104 into the file. The instructions, including the file of selected software blocks, may then be transferred from compiler 118 to a service tool 120 via data interface 108. A technician may use service tool 120 to transfer the instructions to work machine controller 114.

Data interface 108 may also be adapted to receive system parameters, such as a memory size, associated with work machine controller 114. Compiler 118 may generate instructions for work machine controller 114 based on the received system parameters. For example, compiler 118 may prevent compilation or request additional input from a user if a memory size associated with work machine controller 114 is too small.

The instructions may be periodically improved or changed and transferred as updates from service tool 118 to work machine controller 114. For example, if a user desires to modify the instructions, the user may load a graphical representation associated with the instructions and make any desired modifications or additions. A portion of or all of selected software blocks 210 may be retained in a new set of instructions.

Product library 104 may include various previously compiled and verified software blocks. A software block may include object references, which may enable calls to functions associated with the software block. The object references may be verified against a set of interface constraints to facilitate reuse in generating instructions to run on work machine controllers, such as work machine controller 114. Thus, if a new work machine controller is installed or work machine controller 114 is modified on work machine 116, a portion of the software blocks used in work machine controller 114 may be reused with little or no modification. For example, a software block may carry out a common function such as implementing a clutch algorithm. In addition, common functions may be designed, compiled, and verified once and used thereafter in multiple work machine controllers, thereby streamlining development and deployment of instructions.

Product library 104 may also include software blocks associated with hardware equipment, such as sensors, communications devices, clutches, engines, and other items that may be on board work machine 114. While FIG. 1 depicts product library 104 as being remote from consoles 102, product library 104 may also be stored local to one of consoles 102.

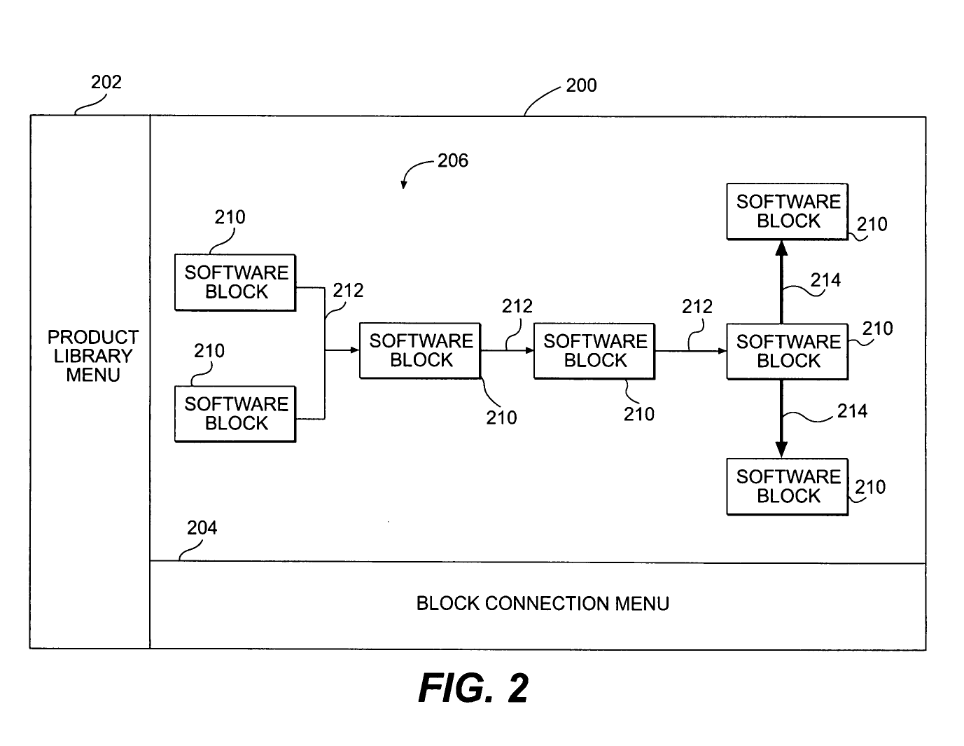

FIG. 2 provides an exemplary view of a user interface 200 that software design tool 112 may display to facilitate design of software instructions. User interface 200 may display one or more menus, such as product library menu 202 and block connection menu 204, and a graphical representation 206 of instructions. Graphical representation 206 may include selected software blocks 210 and selected connections between software blocks 210, the selected connections including signal flow connections 212 and object reference connections 214. User interface 200 may also provide options (not shown) for saving, loading, and printing of graphical representations. In addition, user interface 200 may provide a menu or window (not shown) permitting searches for software blocks within product library 104 based on user-specified criteria.

Product library menu 202 may permit a user to select software blocks 210 from product library 104. Thus, a user of software design tool 112 may select software blocks from product library menu 202 for use in designing and automatically generating instructions to run on work machine controller 114. Product library menu 202 may present a selection of software blocks organized by various categories. Categories may be, for example, parts of a work machine associated with particular functions. Product library menu 202 may also organize sub-functions under broader functions and may permit selection of a group of software blocks required for implementing one or more sub-functions.

Block connection menu 204 may present a selection of various connections or associations, including signal flow connections 212 and object reference connections 214, for connecting software blocks 210 in a desired arrangement.

Signal flow connections 212 may represent a directional data flow connection from one of software blocks 210 to another one of software blocks 210. For example, one of software blocks 210 may output data that feeds into another one of software blocks 210. Thus, a relationship of data flowing from an output of one of software blocks 210 to an input of another one of software blocks 210 may be represented by signal flow connection 212.

Object reference connections 214, also known in the art as “associations,” may differ from signal flow connections 212 in that object reference connections 214 may represent various types of relationships or connections between software blocks 210, including, for example, transmission of data, reception of data, performance of functional operations on a connected software block 210, or various combinations of each type, such as a bi-directional data flow connection. Signal flow connections 212, on the other hand, depict only one type of relationship between two software blocks 210, that is, a directional data flow relationship as described above.

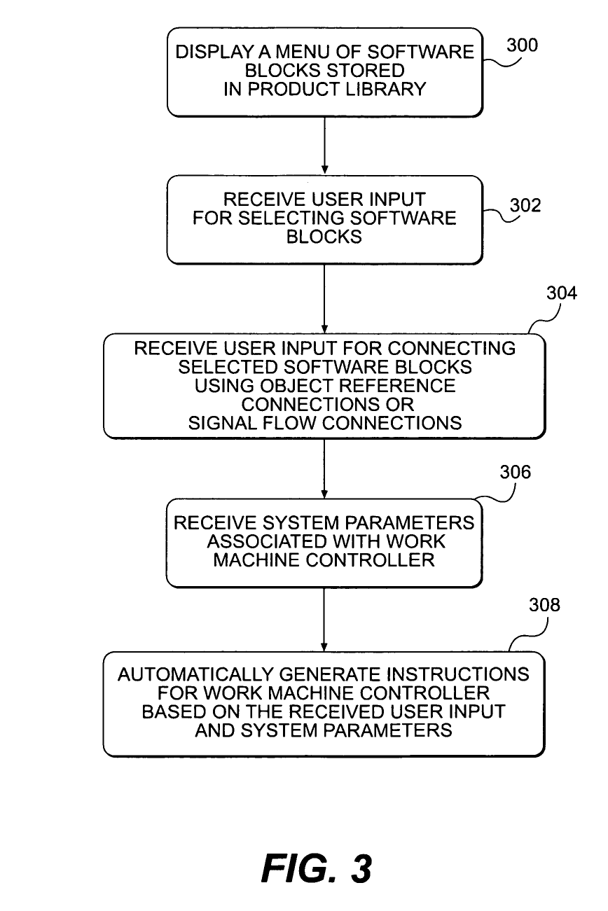

FIG. 3 provides an illustration of an exemplary method that may be carried out to design and generate instructions for execution on work machine controller 114. Starting at step 300, console 102 may display product library menu 202 to a user. In step 302, user input may be received for selecting software blocks 210. In step 304, user input may be received via block connection menu 204 for connecting selected software blocks 210 using object reference connections 214 or signal flow connections 212. Step 306 includes receiving system parameters associated with work machine controller 114. Finally, in step 308, instructions for work machine controller 114 may be automatically generated based on the received user input, including graphical representation 206, and system parameters associated with work machine controller 114.

### INDUSTRIAL APPLICABILITY

The disclosed system and method for automatically generating instructions for a computing device may be used to develop software to run on any platform. In one exemplary disclosed embodiment, the system and method may be used to develop software to run on a work machine controller 114.

The presently disclosed system and method for automatically generating instructions for a computing device have several advantages. First, the disclosed system and method permit a combination of software modeling or design methodologies. For example, signal flow connections apply a control theory methodology, whereas object reference connections apply an object oriented methodology.

Moreover, because the disclosed system and method permit different software design methodologies, a designer may use the most effective methodology applicable to each aspect of a software system. For instance, one methodology may be most effective for designing network communications software. Another methodology may be most effective for designing a clutch control algorithm. If an overall software system includes a clutch control algorithm interacting with network communications software, then a design that combines both methodologies is maximally effective. Thus, a designer using the disclosed system and method need not balance the pros and cons of using one methodology over the other for designing the system. Rather, the designer using the disclosed system and method may use both methodologies to obtain advantages of each.

It will be apparent to those skilled in the art that various modifications and variations can be made in the disclosed system and method for software component design without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A system for designing and generating instructions for a computing device, the system comprising:
a library configured to store software blocks; and
a console including a user interface for receiving user input and displaying graphical representations of software blocks selected from the library,
wherein the user interface is adapted to permit a selection of graphical connections between the graphical representations, the selection of graphical connections including an object reference connection and a signal flow connection.

2. The system of claim 1, wherein the object reference connection represents one of a plurality of types of connections.

3. The system of claim 1, wherein the signal flow connection represents a directional data flow connection.

4. The system of claim 1, further including a compiler for generating the instructions based on the graphical representations of the software blocks and the graphical connections.

5. The system of claim 4, wherein the console includes a data interface adapted to receive system parameters associated with a work machine controller configured to implement the instructions and the compiler generates the instructions based on the system parameters.

6. The system of claim 1, wherein the library configured to store the software blocks is stored local to the console.

7. The system of claim 1, wherein:
the library configured to store the software blocks is stored remote from the console; and
the console includes a data interface for remotely accessing the library configured to store the software blocks.

8. The system of claim 1, wherein the user interface includes a menu for selecting the software blocks.

9. The system of claim 1, wherein the user interface includes a menu for selecting the graphical connections between the graphical representations of the software blocks.

10. A method for designing and generating instructions for a computing device, the method comprising:
displaying, through a user interface, a menu associated with software blocks;
receiving input, through the user interface, for selecting software blocks from the menu and for connecting the selected software blocks; and
automatically generating the instructions based on the received input,
wherein the user interface is adapted to permit a selection of graphical connections between the graphical representations, the selection of graphical connections including an object reference connection and a signal flow connection.

11. The method of claim 10, wherein the object reference connection represents one of a plurality of types of connections.

12. The method of claim 10, wherein the signal flow connection represents a directional data flow connection.

13. The method of claim 10, wherein the generated instructions include a file for storing the selected software blocks, the method further including:
transferring to the file the selected software blocks from a library configured to store the software blocks.

14. The method of claim 13, wherein the library configured to store the software blocks is stored local to a console adapted to display the menu of software blocks.

15. The method of claim 13, wherein the library configured to store the software blocks is stored remote from a console configured to display the menu of software blocks, and the console includes a data interface for remotely accessing the library configured to store the software blocks.

16. The method of claim 10, further including:
receiving, through a data interface, system parameters associated with a work machine controller configured to implement the instructions; and
automatically generating the instructions based on the system parameters.

17. The method of claim 10, wherein the menu associated with software blocks is a first menu and wherein receiving input, through the user interface, for connecting the selected blocks includes displaying a second menu adapted to permit the selection of graphical connections between the graphical representations of the software blocks.
